(19) United States
(12) Patent Application Publication
(10) Pub. No.: US 2024/0169961 A1
(43) Pub. Date: May 23, 2024

(54) METHOD AND APPARATUS FOR DETERMINING AUDIO, ELECTRONIC DEVICE, AND STORAGE MEDIUM

(71) Applicants: Beijing Zitiao Network Technology Co., Ltd., Beijing (CN); Lemon Inc., Grand Cayman (KY); Douyin Vision Co., Ltd., Beijing (CN)

(72) Inventors: Shuai YUAN, Beijing (CN); Bochen LI, Los Angeles, CA (US); Qiuhong XU, Beijing (CN); Na ZHAO, Beijing (CN); Zhengyi FANG, Beijing (CN); Peidao LI, Beijing (CN); Shengli WANG, Beijing (CN)

(21) Appl. No.: 18/448,857

(22) Filed: Aug. 11, 2023

(30) Foreign Application Priority Data
Nov. 18, 2022 (CN) 202211449203.X

(51) Int. Cl. G10H 1/00

(52) U.S. Cl. CPC G10H 1/0008; G10H 2210/105; G10H 2210/151; G10H 2210/571; G10H 2220/126

(57) ABSTRACT

Provided are a method and apparatus for determining an audio, an electronic device, and a storage medium. The method includes: a chord corresponding to an input audio is determined in response to receiving the input audio; at least one to-be-selected arrangement style is determined according to the chord and/or a melody attribute of the input audio; at least one to-be-selected arrangement template associated with a target arrangement style is displayed based on a trigger operation to the at least one to-be-selected arrangement style; and a target audio is played based on a trigger operation to the at least one to-be-selected arrangement template.

### CROSS-REFERENCE TO RELATED APPLICATION(S)

This application claims priority to Chinese Patent Application No. 202211449203.X filed Nov. 18, 2022, the disclosure of which is incorporated herein by reference in its entirety.

### TECHNICAL FIELD

Embodiments of the present disclosure relate to audio processing technologies, and in particular to, a method and apparatus for determining an audio, an electronic device, and a storage medium.

### BACKGROUND

At present, many application software has certain audio editing properties, and a user may edit and process audio information by using corresponding functions.

However, an existing audio editing software is only limited to editing an input audio according to the user requirements, which requires a manual participation, and correspondingly, when the manual participation is involved, the audio obtained by editing has a great relationship with the preference degree of the user, and target audios of different styles cannot be obtained by editing. That is, the existing audio editing software not only has simple editing function, but also needs the manual participation in audio editing, so that the obtained target audio has a single style, and further, problems of low professionalism and low personalization are caused.

### SUMMARY

The present disclosure provides a method and apparatus for determining an audio, an electronic device, and a storage medium, so that a target arrangement template is determined based on an input audio entered by a user and a trigger operation to an arrangement template by the user, whereby the effect of fusing the input audio to a target audio of the target arrangement template is obtained, the personalized requirements of the user are satisfied, the use experience of the user on an application software is improved, and meanwhile, the interactive experience of the user and a display interface is improved.

In a first aspect, an embodiment of the present disclosure provides a method for determining an audio, the method includes that: a chord corresponding to an input audio is determined in response to receiving the input audio; at least one to-be-selected arrangement style is determined according to the chord and/or a melody attribute of the input audio; at least one to-be-selected arrangement template associated with a target arrangement style is displayed based on a trigger operation to the at least one to-be-selected arrangement style; and a target audio is played based on a trigger operation to the at least one to-be-selected arrangement template. The target audio is an audio obtained after the input audio is merged to a target arrangement template, and the at least one to-be-selected arrangement template includes the target arrangement template.

In a second aspect, an embodiment of the present disclosure further provides an apparatus for determining an audio, the apparatus includes a chord determination module, a to-be-selected arrangement style determination module, a to-be-selected arrangement template display module, and a target audio playing module. The chord determination module is configured to determine a chord corresponding to an input audio in response to receiving the input audio. The to-be-selected arrangement style determination module is configured to determine at least one to-be-selected arrangement style according to the chord and/or a melody attribute of the input audio. The to-be-selected arrangement template display module is configured to display, based on a trigger operation to the at least one to-be-selected arrangement style, at least one to-be-selected arrangement template associated with a target arrangement style. The target audio playing module is configured to play a target audio based on a trigger operation to the at least one to-be-selected arrangement template, where the target audio is an audio obtained after the input audio is merged to a target arrangement template, and the at least one to-be-selected arrangement template includes the target arrangement template.

In a third aspect, an embodiment of the present disclosure further provides an electronic device. The electronic device includes one or more processors and a storage apparatus. The storage apparatus is configured to store one or more programs. The one or more programs, when executed by the one or more processors, cause the one or more processors to implement the method for determining the audio of any one of the embodiments of the present disclosure.

In a fourth aspect, an embodiment of the present disclosure further provides a non-transitory storage medium including a computer-executable instruction. The computer-executable instruction is configured to perform, when executed by a computer processor, the method for determining the audio of any one of the embodiments of the present disclosure.

According to technical schemes of the embodiments of the present disclosure, the chord corresponding to the input audio is determined in response to receiving the input audio, then the at least one to-be-selected arrangement style is determined according to the chord and/or the melody attribute of the input audio, the at least one to-be-selected arrangement template associated with the target arrangement style is displayed based on the trigger operation to the at least one to-be-selected arrangement style, and the target audio is played based on the trigger operation to the at least one to-be-selected arrangement template, so that problems that in the related art, the personalized customization cannot be performed on the input audio entered by the user and certain limitations exist are solved, the target arrangement template is determined based on the input audio entered by the user and the trigger operation to the arrangement template by the user, whereby the effect of fusing the input audio to the target audio of the target arrangement template is obtained, the personalized requirements of the user are satisfied, the use experience of the user on the application software is improved, and meanwhile, the interactive experience of the user and the display interface is improved.

### BRIEF DESCRIPTION OF DRAWINGS

The above and other features, advantages and aspects of embodiments of the present disclosure will become more apparent by referring to the following detailed description when taken in conjunction with the drawings. Throughout the drawings, the same or similar reference numerals refer to the same or similar elements. It should be understood that the drawings are schematic and that the components and elements are not necessarily drawn to scale.

FIG. 1 is a flowchart of a method for determining an audio according to an embodiment of the present disclosure;

FIG. 2 is a schematic diagram of an input audio collection interface according to an embodiment of the present disclosure;

FIG. 3 is a flowchart of a method for determining an audio according to an embodiment of the present disclosure;

FIG. 4 is a schematic diagram of a chord preview interface according to an embodiment of the present disclosure;

FIG. 5 is a schematic diagram of a style template presentation interface according to an embodiment of the present disclosure;

FIG. 6 is a schematic diagram of a style template presentation interface according to an embodiment of the present disclosure;

FIG. 7 is a schematic diagram of a style template presentation interface according to an embodiment of the present disclosure;

FIG. 8 is a schematic diagram of a display interface according to an embodiment of the present disclosure;

FIG. 9 is a schematic diagram of a target interface according to an embodiment of the present disclosure;

FIG. 10 is a schematic structural diagram of an apparatus for determining an audio according to an embodiment of the present disclosure; and

FIG. 11 is a schematic structural diagram of an electronic device according to an embodiment of the present disclosure.

### DETAILED DESCRIPTION

Embodiments of the present disclosure will be described in more detail below with reference to the drawings. While certain embodiments of the present disclosure are illustrated in the drawings, it should be understood that the present disclosure may be embodied in various forms and should not be construed as limited to the embodiments set forth herein, but rather, these embodiments are provided for a more thorough and complete understanding of the present disclosure. It should be understood that the drawings and the embodiments of the present disclosure are for exemplary purposes only and are not intended to limit the scope of protection of the present disclosure.

It should be understood that various steps recited in method implementations of the present disclosure may be performed in a different order, and/or performed in parallel. Moreover, the method implementations may include additional steps and/or omit the performance of illustrated steps. The scope of the present disclosure is not limited in this regard.

As used herein, the term “include” and its variants are open inclusive, that is, “including, but not limited to”. The term “based on” is “based at least in part on”. The term “one embodiment” represents “at least one embodiment”. The term “another embodiment” represents “at least one further embodiment”. The term “some embodiments” represents “at least some embodiments”. Relevant definitions for other terms will be given in the description below:

It should be noted that the concepts of “first”, “second” and the like mentioned in the present disclosure are only used to distinguish between different apparatuses, modules or units, and are not used to limit the order or interdependence of the functions performed by these apparatuses, modules or units.

It should be noted that a modification as “one” or “multiple” mentioned in the present disclosure are intended to be illustrative rather than limiting, and it should be understood by those skilled in the art that the modification as “one” or “multiple” mentioned in the present disclosure should be understood as “one or more” unless the context clearly dictates otherwise.

The names of messages or information interacted between apparatuses in the implementations of the present disclosure are for illustrative purposes only, and are not intended to limit the scope of such messages or information.

It should be understood that prior to the use of technical schemes disclosed in the embodiments of the present disclosure, the user should be informed of the type, scope of use, scenario of use, and the like of personal information referred to in the present disclosure in an appropriate manner in accordance with the relevant laws and regulations, and the user's authorization may be obtained.

For example, in response to receiving an active request from the user, prompt information is sent to the user to explicitly prompt the user that the operation requested to be performed will require the acquisition and use of personal information to the user. Thus, the user may autonomously select, based on the prompt information, whether to provide the personal information to software or hardware performing operations of technical schemes of the present disclosure, such as an electronic device, an application program, a server, or a storage medium.

As an optional but non-limiting implementation, in response to receiving an active request from the user, a manner of sending the prompt information to the user may be, for example, a manner of a pop-up window in which the prompt information may be presented in a text manner. In addition, the pop-up window may also bear a selection control for the user to select to “agree” or “disagree” so as to provide the personal information to the electronic device.

It should be understood that the above-described process of notifying and acquiring the user authorization is merely illustrative and does not constitute a limitation to the implementation of the present disclosure, and other manners of satisfying the relevant laws and regulations may be applied to the implementation of the present disclosure.

It should be understood that the data (including but not limited to the data itself, acquisition or use of the data) to which this technical scheme relates shall follow the requirements of the corresponding laws and regulations and related provisions.

Before this technical scheme is introduced, the application scenarios may be exemplarily explained firstly. The technical schemes of the embodiments of the present disclosure may be applied in an arbitrary special effect video shooting scenario, or applied in a normal audio collection scenario. Exemplarily, in the special effect video shooting scenario, audio information of the user may be collected, the audio information of the user is used as an input audio, then a respective to-be-selected arrangement style and a to-be-selected arrangement template associated with the to-be-selected arrangement style are determined through analyzing the input audio, and further, a target audio for fusing the input audio to a target arrangement template is generated through a trigger operation to the to-be-selected arrangement template, whereby an effect of superimposing a target audio special effect on the basis of the special effect video processing may be achieved. In the normal audio collection scenario, this technical scheme may be integrated in any application software that may collect the audio information, or integrated in application software specifically developed by developers, the collected audio information is used as the input audio, a respective to-be-selected arrangement style and a to-be-selected arrangement template associated with each to-be-selected arrangement style are determined through analyzing the input audio, and further, a target arrangement template is obtained through the trigger operation to the to-be-selected arrangement template, so that the effect of personalized customization of the to-be-selected arrangement template based on the user requirements is achieved, and thus a target audio for fusing the input audio into the target arrangement template is obtained finally.

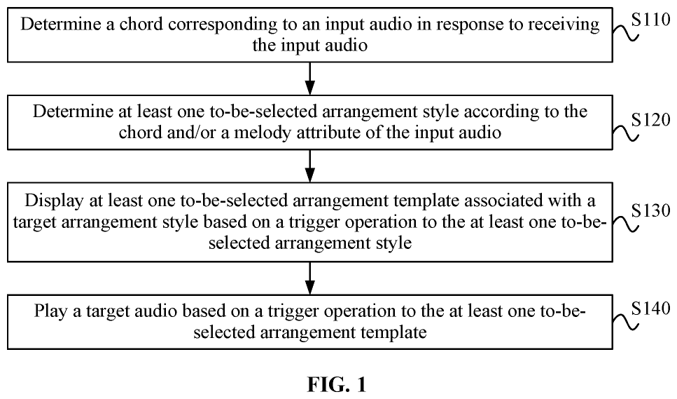

FIG. 1 is a flowchart of a method for determining an audio according to an embodiment of the present disclosure. The embodiment of the present disclosure is applicable to a case where a received input audio is merged to a customized arrangement module to obtain a target audio. The method may be performed by an apparatus for determining an audio, the apparatus may be implemented in the form of software and/or hardware, optionally, the apparatus may be implemented by an electronic device, and the electronic device may be a mobile terminal, a PC terminal, a server, and the like.

As shown in FIG. 1, the method includes steps described below.

In S110, a chord corresponding to an input audio is determined in response to receiving the input audio.

In this embodiment, the input audio may be a sequence of musical tones composed of human sounds and having a certain rhythm relationship and a high-low relationship. Here, the human sound may be a sound emitted due to vibration of vocal cords. A melody is composed of series of tones of different or identical pitch, and is a sequence of tones associated with a particular high-low tone relationship and a rhythm relationship. It should be understood by those skilled in the art that the chord refers to a group of sounds having a certain musical interval relationship, that is, three or more tones are combined in a longitudinal direction in an overlapping relationship of three-degree or non-three-degree, which is referred to as the chord.

In a practical application, an input audio collection control may be preset, and in response to detecting that the user triggers the control, a melody issued by the user may be collected, and the collected melody is used as the input audio, and then the chord corresponding to the input audio is determined.

It should be noted that the technical schemes provided in the embodiments of the present disclosure may be applied to a special effect video shooting scenario, in this special effect video shooting scenario, not only a video image may be processed, but also audio information may be processed, that is, audio special effects are superimposed on the basis of video image processing. It may also be applied in a normal audio collection scenario, for example, it may be integrated in any application software that may collect the audio, or in specially developed application software. Different application scenarios may correspond to different input audio collection manners, and the input audio collection manners in the different application scenarios may be described below, respectively.

One manner may be that: audio information of a target user is collected in response to a special effect trigger operation, and the audio information of the target user is used as the input audio.

In this embodiment, in the application software or the application program supporting the special effect video processing function, a control for triggering the special effect may be pre-developed. In response to detecting that the user triggers the control, the audio information of the target user may be collected in response to the special effect trigger operation, and the collected audio information may be used as input audio.

The target user may be a user who emits a sound due to vocal cord vibration. The audio information may be a multimedia data stream storing a sound content, while the sound content stored in the data stream may be sound information emitted by the target user.

In a practical application, in response to detecting that the user triggers the special effect operation, a terminal device may be disposed to be close to the target user to collect the audio information, and in response to detecting that the vocal cord of the target user emits sound, sound information currently emitted may be collected to obtain the audio information of the target user, and the collected audio information is used as the input audio.

It should be noted that the audio information of the target user is collected only in a case where certain special effect operations are triggered, and then the special effect trigger operation may include at least one of: the triggering of a special effect prop; the audio information being triggered a special effect wakeup word; or the current limb action being consistent with the preset special effect action.

In this embodiment, a control for triggering the special effect prop may be preset, and in response to detecting that the user triggers the control, a special effect prop display page may be popped up on a display interface, and multiple special effect props may be displayed in the display page. The user may trigger a corresponding special effect prop, and in response to detecting that the user triggers a special effect prop corresponding to the collected audio information, it indicates that the special effect trigger operation is triggered. In another implementation, the audio information of the user may be collected in advance, and the audio information is analyzed to identify a text corresponding to the audio information. If the text corresponding to the audio information includes a preset wakeup word, optionally, the wakeup word may be a vocabulary of the type “please collect the current melody” or “please turn on the special effect function”, which means that the audio information of the target user may be acquired. In another implementation, some limb actions may be set as special effect triggering actions in advance, and in response to detecting that the limb actions currently performed by the user in the field of view coincide with the preset limb actions, it may be determined that the special effect trigger operation is triggered. Optionally, the preset limb actions may be hand lifting or mouth opening, and the like.

Another manner may be that: the collected audio information may be used as the input audio in response to detecting that the audio collection control is triggered.

In this embodiment, in any application program capable of acquiring the audio information, or in an application program specially developed based on the technical schemes of the embodiments of the present disclosure, the audio collection control may be preset. In response to detecting that the user triggers the control, the audio information of the target user may be collected, and the collected audio information is used as the input audio. Further, the chord corresponding to the input audio may be determined in response to receiving the input audio.

It should be noted that the beneficial effect of collecting the input audio based on the above-described two manners is that the effect of applying this technical scheme to different application scenarios is achieved, and the application flexibility of this technical scheme is enhanced.

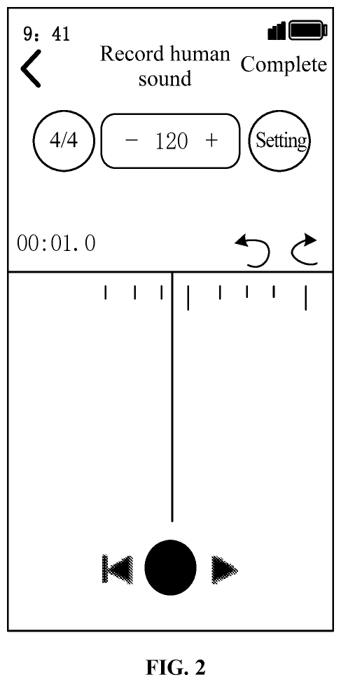

Exemplarily, the collection process of the input audio may be described with reference to FIG. 2. Specifically, the acquisition operation of the audio information may be performed when a trigger operation to a circular control in a bottom region of FIG. 2 is detected, and the collected audio information may be displayed through a voiceprint, moreover, the collection process is clocked, and a tempo and a meter adjustment control are set in a top region of the input audio collection interface, so that the user may customize the tempo and the meter of the input audio, and in response to detecting that the trigger operation to the control is completed, a collection process of the input audio may be considered to be ended, and then the collection process of the input audio may jump to the next interface.

It should be noted that in the practical application process, in response to receiving the input audio, the terminal device may recognize a melody line of the input audio based on a preset algorithm, and further, the chord corresponding to the input audio may be obtained.

In S120, at least one to-be-selected arrangement style is determined according to the chord and/or a melody attribute of the input audio.

In this embodiment, the melody attribute may be used to characterize the basic music elements contained in the melody, and optionally, the melody attribute includes a tempo, a rhythm, a meter, a strength, a tone, and the like. The to-be-selected arrangement style may be of an audio special effect type for stylized arrangement of the audio information. Optionally, the to-be-selected arrangement style may include, but is not limited to, a popular arrangement style, a jazz arrangement style, a dance arrangement style, a hip-hop arrangement style, a reggae arrangement style, and the like.

In the practical application process, after the input audio is received and the chord corresponding to the input audio is determined, the at least one to-be-selected arrangement style may be determined. It should be noted that when the to-be-selected arrangement style is determined, the to-be-selected arrangement style may be determined according to the chord, or may be determined according to the melody attribute of the input audio, or may be determined according to the chord and the melody attribute of the input audio. Manners of determining the to-be-selected arrangement style are described below, respectively.

Optionally, that the at least one to-be-selected arrangement style is determined according to the melody attribute of the input audio includes: the at least one to-be-selected arrangement style is determined from multiple to-be-matched arrangement styles according to a tempo and/or a meter.

Here, the tempo may be used to characterize how fast or slow the melody is. The tempo is typically in units of “meters per minute (bpm)”. Exemplarily, the tempo may be 110 bpm, 120 bpm, or 140 bpm, among others. Meters, which are units that measure rhythm, represent fixed unit time values and organizational forms of strong and weak laws in a piece of music. In music, a series of meters of a certain strength and weakness are repeated at regular intervals, exemplarily, 2/4 meters, 4/4 meters or 3/4 meters, and the like.

In a specific implementation, at least one tempo and/or meter may be predetermined, and at least one arrangement style adapted to each tempo and/or meter is determined, moreover, a corresponding melody identification is provided for each tempo and/or meter, so that each arrangement style and a melody identification corresponding to each arrangement style are correspondingly stored in a database, and at this time, the arrangement styles stored in the database may be used as the to-be-matched arrangement styles. In the practical application process, when the input audio is received and the tempo and/or meter of the input audio is determined, a melody identification corresponding to the tempo and/or meter may be determined, and the at least one to-be-selected arrangement style may be determined from multiple pre-stored to-be-matched arrangement styles according to the melody identification. This arrangement has the advantages that the matching between the to-be-selected arrangement style and the input audio is improved, and further, the recommended intelligence of the application software is improved.

Optionally, that the at least one to-be-selected arrangement style is determined according to the melody attribute of the input audio and the chord includes: the at least one to-be-selected arrangement style is determined from multiple to-be-matched arrangement styles according to the tempo, the meter and the chord.

In the practical application process, at least one tempo, meter, and chord may be predetermined, at least one arrangement style corresponding to each tempo and each meter is determined, and at least one arrangement style corresponding to each chord is determined. Moreover, a corresponding melody identification is provided for each tempo and each meter, so that each arrangement style and a melody identification corresponding to each arrangement style are correspondingly stored in the database, and a corresponding chord identification is provided for each chord, so that each arrangement style and a chord identification corresponding to each arrangement style are correspondingly stored in the database, and at this time, the arrangement styles stored in the database may be used as the to-be-matched arrangement styles.

In a specific implementation, after the input audio is received and the melody attribute of the input audio and the chord corresponding to the input audio are determined, a melody identification corresponding to the melody attribute and a chord identification corresponding to the chord may be determined. Further, a first arrangement style corresponding to the melody attribute may be determined from multiple to-be-matched arrangement styles corresponding to the melody identification according to the melody identification, and meanwhile, a second arrangement style corresponding to the chord may be determined from the multiple to-be-matched arrangement styles corresponding to the chord identification according to the chord identification. At this time, it is possible to determine a union set including the first arrangement style and the second arrangement style to obtain the at least one to-be-selected arrangement style; an intersection of the first arrangement style and the second arrangement style may also be determined to obtain the at least one to-be-selected arrangement style. This arrangement has the advantages that the flexibility and diversity in the manner of determining the to-be-selected arrangement style is enhanced, the adaptability of the to-be-selected arrangement style to the input audio and the chord is improved, and further, the matching accuracy of the to-be-selected arrangement style is improved.

In S130, at least one to-be-selected arrangement template associated with a target arrangement style is displayed based on a trigger operation to the at least one to-be-selected arrangement style.

The at least one to-be-selected arrangement template includes a target arrangement template.

In this embodiment, the target arrangement style may be an arrangement style determined based on a trigger operation of the user in the at least one to-be-selected arrangement style. The to-be-selected arrangement template may be a template for characterizing musical instrument information contained in the corresponding arrangement style and an articulation corresponding to each meter. The to-be-selected arrangement template is an arrangement template for fusing the input audio. In the practical application process, the user may process the collected input audio based on the to-be-selected arrangement template so as to obtain an audio that fuses the input audio into the to-be-selected arrangement template. Optionally, musical instruments contained in the to-be-selected arrangement template may include, but are not limited to, Beth, a keyboard, a drum, a striking pad, an engaging drum set, and the like. The articulation may include, but is not limited to, a crawl sound, a jump sound, a down sound, and the like.

It should be noted that the to-be-selected arrangement template may be a sub-style of a corresponding to-be-selected arrangement style, that is, each to-be-selected arrangement style may be associated with at least one to-be-selected arrangement template. Exemplarily, if the to-be-selected arrangement style is a pop arrangement style, then a to-be-selected arrangement template associated with the popular arrangement style may include electronic pop, Chinese pop, popular rock, and the like.

In this embodiment, a corresponding style representation image and/or style name may be preset for each to-be-matched arrangement style, and meanwhile, a special effect trigger control is developed in advance for each style representation image and/or each style name, and each style representation image and/or each style name and a to-be-matched arrangement style corresponding to each style representation image and/or each style name are correspondingly stored in the database. In the practical application process, while the at least one to-be-selected arrangement style is determined from the multiple to-be-matched arrangement styles, a style representation image and/or a style name corresponding to each to-be-selected arrangement style may also be determined. When a trigger operation to a special effect trigger control corresponding to at least one style representation image and/or style name by the user is detected, it is possible to determine a to-be-selected arrangement style corresponding to the trigger operation. The to-be-selected arrangement style may be used as the target arrangement style, and further, at least one to-be-selected arrangement template associated with the target arrangement style is determined.

In this embodiment, after the at least one to-be-matched arrangement style is determined, at least one to-be-matched arrangement template associated with each to-be-matched arrangement style may be determined, and each to-be-matched arrangement template and a to-be-matched arrangement style corresponding to each to-be-matched arrangement template are correspondingly stored in the database. In the practical application process, when the target arrangement style is determined, at least one to-be-matched arrangement template associated with the target arrangement style may be retrieved from the database.

In S140, a target audio is played based on a trigger operation to the at least one to-be-selected arrangement template.

The target audio is an audio obtained after the input audio is merged to the target arrangement template. In this embodiment, a trigger control may be pre-developed in any display region of musical instrument information contained in each to-be-selected arrangement template and the articulation corresponding to each meter. When a trigger operation to the musical instrument information is detected, at least one tone color associated with the musical instrument information may be presented, and a tone color corresponding to the musical instrument information may be determined by the trigger operation to the at least one tone color. Meanwhile, when a trigger operation to the articulation of each meter is detected, at least one articulation associated with this meter may be presented, and the articulation corresponding to the meter may be determined by the trigger operation to the at least one articulation. At this time, the to-be-selected arrangement template obtained at this time may be used as the target arrangement template.

In the practical application process, when a trigger operation to at least one to-be-selected arrangement template is detected, the target arrangement template corresponding to the trigger operation may be determined, and further, the received input audio may be merged to the target arrangement template so as to obtain the target audio and play the target audio.

According to the technical schemes of the embodiments of the present disclosure, the chord corresponding to the input audio is determined in response to receiving the input audio, then the at least one to-be-selected arrangement style is determined according to the chord and/or the melody attribute of the input audio, the at least one to-be-selected arrangement template associated with the target arrangement style is displayed based on the trigger operation to the at least one to-be-selected arrangement style, and the target audio is played based on the trigger operation to the at least one to-be-selected arrangement template, so that problems that in the related art, the personalized customization cannot be performed on the input audio entered by the user and certain limitations exist are solved, the target arrangement template is determined based on the input audio entered by the user and the trigger operation to the arrangement template by the user, whereby the effect of fusing the input audio to the target audio of the target arrangement template is obtained, the personalized requirements of the user are satisfied, the use experience of the user on the application software is improved, and meanwhile, the interactive experience of the user and the display interface is improved.

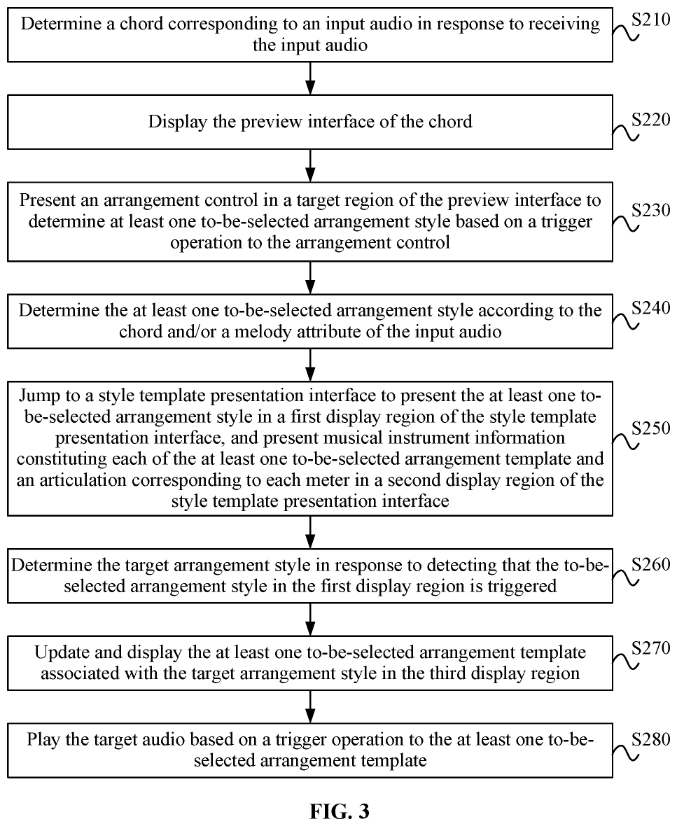

FIG. 3 is a flowchart of a method for determining an audio according to an embodiment of the present disclosure. Based on the foregoing embodiments, after the chord and the to-be-selected arrangement style are determined, the chord and the to-be-selected arrangement style may be visually presented, and a preview interface of the chord and a style template presentation interface of the to-be-selected arrangement style are presented in the display interface, so that the user may obtain the target audio through a trigger operation to the corresponding region. For specific implementations thereof, reference may be made to the technical scheme of this embodiment. Here, technical terms identical to or corresponding to the above-described embodiments are not described herein.

As shown in FIG. 3, the method specifically includes steps described below.

In S210, a chord corresponding to an input audio is determined in response to receiving the input audio.

In S220, the preview interface of the chord is displayed.

In a practical application, after the chord corresponding to the input audio is determined, a corresponding chord may also be displayed in a pre-developed interface so that the user may superimpose a corresponding sound effect special effect on the collected input audio by a series of interactive operations of the interface.

In this embodiment, the preview interface may be an interface for previewing specific information of the chord.

In a specific implementation, after the chord corresponding to the input audio is determined, the preview interface of the chord may be displayed on the display interface of the terminal device in order to clearly present the determined chord to the user.

In S230, an arrangement control is presented in a target region of the preview interface to determine at least one to-be-selected arrangement style based on a trigger operation to the arrangement control.

In this embodiment, the arrangement control may be a preset control for performing an arrangement operation. Correspondingly, the target region may be any region in the preview interface, and optionally, the target region may be a bottom region of the preview interface.

In a practical application, the arrangement control may be provided in the target region of the preview interface of the chord in advance, and further, when the trigger operation to the arrangement control by the user is detected, the at least one to-be-selected arrangement style may be determined from multiple pre-stored to-be-matched arrangement styles, so that the target audio satisfying the user requirements may be generated by the trigger operation to the at least one to-be-selected arrangement style.

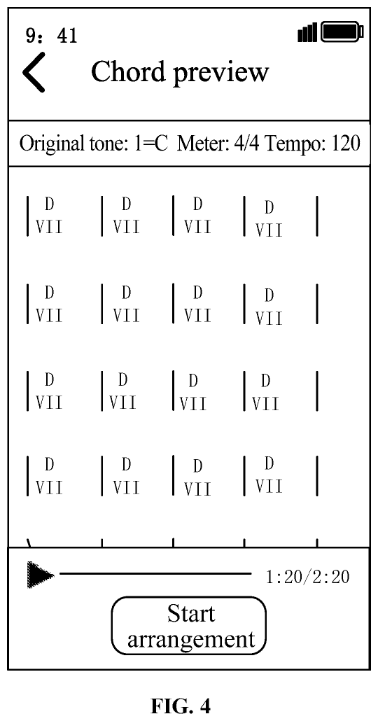

Exemplarily, as shown in FIG. 4, FIG. 4 is a schematic diagram of a preview interface, a bottom region of the interface in FIG. 4 is the target region, a control presented in the target region is an arrangement control, and a middle region of the interface is a specific information presentation region of the chord.

In S240, the at least one to-be-selected arrangement style is determined according to the chord and/or a melody attribute of the input audio.

In S250, it jumps to a style template presentation interface to present the at least one to-be-selected arrangement style in a first display region of the style template presentation interface, and present musical instrument information constituting each of the at least one to-be-selected arrangement template and an articulation corresponding to each meter in a second display region of the style template presentation interface.

It should be noted that, in order to enable the visual presentation of each to-be-selected arrangement style, so that the user may determine a target arrangement style through an interactive operation with the display interface, and may visually present at least one to-be-matched arrangement template associated with the target arrangement style, after the at least one to-be-selected arrangement style is determined, the display interface may also be jumped from the preview interface of the chord to a display interface of the to-be-selected arrangement style.

In this embodiment, the style template presentation interface may be pre-designed and developed so as to present an interface of each style template. The first display region may be any region in the style template presentation interface, and optionally, may be a bottom region in the style template presentation interface. The second display region may be any region in the style template presentation interface, and optionally, may be a middle region in the style template presentation interface. The musical instrument information may be a musical instrument to be played contained in each to-be-selected arrangement template.

In the practical application process, when the trigger operation to the arrangement control presented in the preview interface is detected, it may jump to the style template presentation interface, and further, the at least one to-be-selected arrangement style may be presented in the first display region of the style template presentation interface. At this time, when the trigger operation to the at least one to-be-selected arrangement style is detected, at least one to-be-selected arrangement template associated with the target arrangement style may be determined, and the musical instrument information constituting the each to-be-selected arrangement template and the articulation corresponding to each meter may be presented in the second display region of the style template presentation interface.

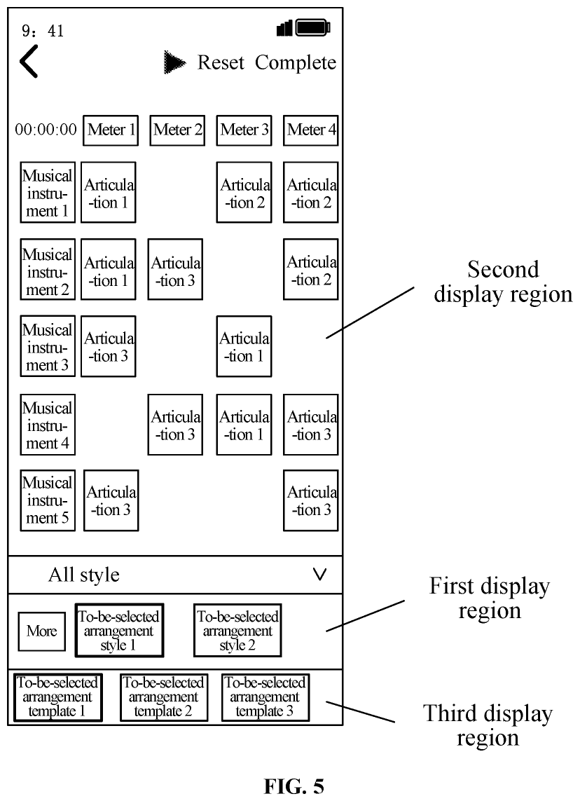

Exemplarily, as shown in FIG. 5, FIG. 5 is a schematic diagram of a style template presentation interface, a bottom region of the interface in FIG. 5 is the first display region, and a middle region of the interface in FIG. 5 is the second display region. At least one to-be-selected arrangement style is presented in the first display region, and the at least one to-be-selected arrangement style may include an arrangement style 1, an arrangement style 2, . . . , an arrangement style N, and the like. Musical instrument information constituting each to-be-selected arrangement template and an articulation corresponding to each meter is presented in the second display region, the musical instrument information may include a musical instrument 1, a musical instrument 2, a musical instrument 3, a musical instrument 4, a musical instrument 5, and the like, the meter may include a meter 1, a meter 2, a meter 3 and a meter 4, and the articulation includes an articulation 1, an articulation 2 and an articulation 3.

It should be noted that when the at least one to-be-selected arrangement style is presented in the first display region, the at least one to-be-selected arrangement style is presented in a preset presentation order, or presented randomly. When the at least one to-be-selected arrangement style is presented in the preset presentation order, the presentation order may be determined based on at least one of the following manners: a matching degree of each of the at least one to-be-selected arrangement style and the input audio; historical selection data of a target user for the at least one to-be-selected arrangement style; or a frequency at which the at least one to-be-selected arrangement style is selected by the target user.

In this embodiment, the matching degree may be a matching degree between the to-be-selected arrangement style and the melody attribute of the input audio, in particular a matching degree between the to-be-selected arrangement style and the tempo and/or meter. In the practical application process, it is possible to determine a matching degree between the tempo and/or meter of each to-be-selected arrangement style and the tempo and/or meter of the received input audio, and present the at least one to-be-selected arrangement style according to a sequence of the matching degree from high to low.

In this embodiment, the historical selection data may be selection appearance frequency data of the target user for the at least one to-be-selected arrangement style. In the practical application process, the historical selection data of the at least one to-be-selected arrangement style by the target user may be acquired, and a selection frequency and/or a selection number corresponding to each to-be-selected arrangement style may be determined by performing the data analysis on the historical selection data, and further, the at least one to-be-selected arrangement style may be presented according to the selection appearance frequency and/or the selection number from high to low.

In this embodiment, a frequency at which the at least one to-be-selected arrangement style is selected by the target user may be acquired based on the background terminal device, and the at least one to-be-selected arrangement style may be presented according to a sequence of the frequency from high to low.

It should be noted that the advantages of determining the presentation order of the to-be-selected arrangement style in the first display region in multiple manners are that: the flexibility and diversity of determination scheme of the presentation order can be enhanced, and the personalized adaptation of the application software to the user is improved.

In the practical application process, when the musical instrument information constituting the each to-be-selected arrangement template and the articulation corresponding to each meter is presented in the second display region, the each to-be-selected arrangement template may also be updated by the trigger operation so as to determine the musical instrument information corresponding to each to-be-selected arrangement template and the articulation corresponding to each meter based on the user requirements.

Based on the above-described technical schemes, the method further includes that: the musical instrument information in the second display region and the articulation corresponding to each meter in the second display region are updated is updated in response to detecting that the to-be-selected arrangement template is updated.

In a practical application, the musical instrument information contained in the to-be-selected arrangement template and the articulation corresponding to each meter may be updated based on the user requirements, and in response to detecting that the to-be-selected arrangement template is updated, the musical instrument information in the second display region and the articulation corresponding to each meter in the second display region may be updated. This arrangement has the advantages that the linkage interaction between the to-be-selected arrangement template and a display content in the second display region is achieved, and that the user can clearly know the musical instrument information contained in the each to-be-selected arrangement template and the articulation corresponding to each meter.

It should be noted that when the musical instrument information in the second display region and the articulation corresponding to each meter in the second display region may be updated, the musical instrument information may be updated only, the articulation corresponding to any meter may be updated only, and the musical instrument information and the articulation may be updated simultaneously. In this embodiment, which content is specifically updated may be determined based on the user requirements, that is, may be determined based on a trigger operation of the user.

Based on the above-described technical schemes, the method further includes that: a display content of the second display region is updated based on a trigger operation to each piece of musical instrument information in the second display region and/or a trigger operation to the articulation corresponding to each meter in the second display region.

In this embodiment, an update trigger control may be pre-developed in a musical instrument information presentation region in the to-be-selected arrangement template and in an articulation display region corresponding to each meter. When a trigger operation to any update trigger control by the user is detected, update information corresponding to the trigger operation may be determined according to the trigger operation, and the display content of the second display region is updated based on the update information. This arrangement has the advantages that the effect of personalizing and customizing the musical instrument information in the each to-be-selected arrangement template and the articulation corresponding to each meter is achieved, and thus the richness and interest of the special effect props are improved.

Optionally, the trigger operation may include at least one of deleting, switching or adding. Deleting of the trigger operation may be to delete an articulation corresponding to a current meter, that is, the current meter does not set any articulation. Switching of the trigger operation may be an operation of switching an articulation of a current meter from one articulation to another articulation. Adding of the trigger operation may be an operation of adding a new articulation on the basis of an original articulation. It should be noted that this arrangement has the advantages that the diversity of the trigger operation can be increased, so that the application software is more suitable for the personalized needs of the user, and further, the use experience of the user is improved.

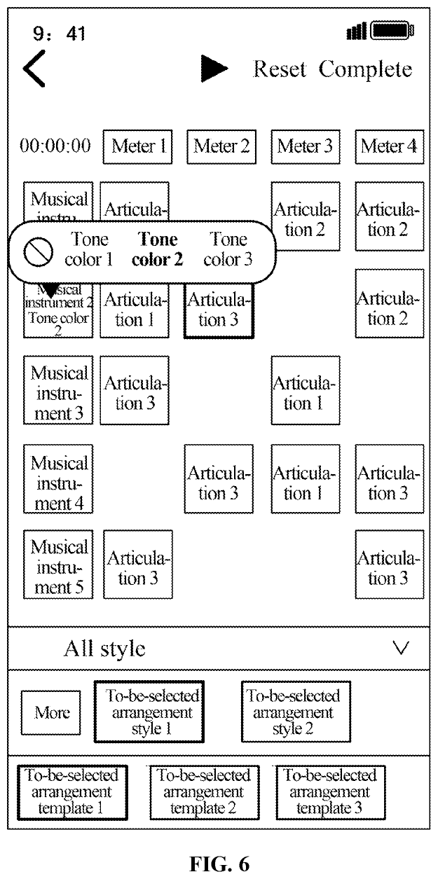

Exemplarily, an update process of musical instrument information may be described in connection with FIG. 6. When a trigger operation to the musical instrument by the user 2 is detected, at least one update control associated with the musical instrument 2 may be presented in any region around the musical instrument 2, and the at least one update control is the tone color 1 control, the tone color 2 control, the tone color 3 control, the delete control and the add control. When a trigger operation to the tone color 2 control by the user is detected, the tone color of the musical instrument 2 may be switched to a tone color corresponding to the tone color 2 control. At this time, an articulation corresponding to each meter associated with the musical instrument 2 is switched to play based on the tone color corresponding to the tone color 2 control, so that the display content in the second display region may be updated.

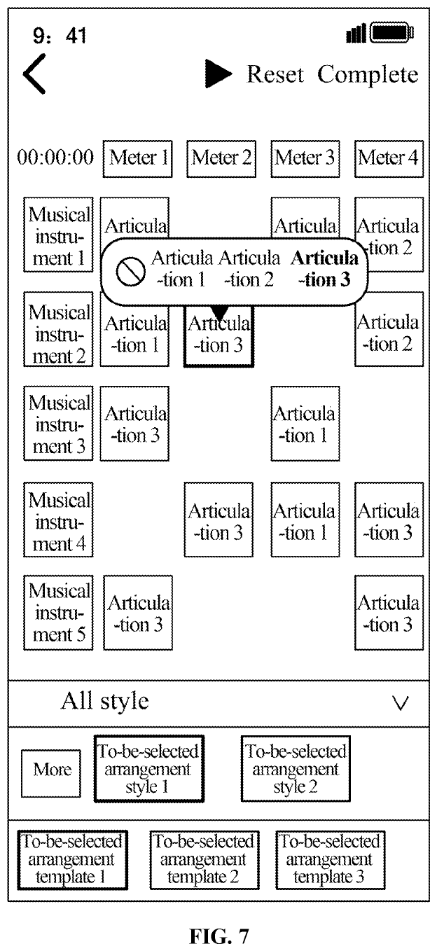

Exemplarily, an update process of the articulation corresponding to each meter may be described in conjunction with FIG. 7. In response to detecting that a trigger operation to an articulation corresponding to the meter 2 in the musical instrument 2 by the user, at least one update control associated with the articulation, that is, an articulation 1 control, an articulation 2 control, an articulation 3 control, a delete control, and an add control, may be presented in any region around the display region of the articulation. In response to detecting that a trigger operation to the articulation 3 control by the user, the articulation corresponding to the meter 2 in the musical instrument 2 may be switched to the articulation 3, and the display content of the second display region may be updated based on the trigger operation, that is, a name corresponding to the articulation 3 may be displayed in a display region of the articulation corresponding to the meter 2 in the musical instrument 2. This arrangement has the advantages described below.

It should be noted that after the at least one to-be-selected arrangement style is determined, it is also possible to determine at least one to-be-selected arrangement template associated with the at least one to-be-selected arrangement style, and to present each to-be-selected arrangement template in a respective display region while each to-be-selected arrangement style is displayed in the first display region according to a preset presentation order so that the user may perform the trigger operation to the to-be-selected arrangement template and may update the display content in the second display region.

Based on the above-described technical schemes, the method further includes that: at least one to-be-selected arrangement template associated with a to-be-selected arrangement style first presented in the first display region is presented in a third display region of the style template presentation interface.

In this embodiment, the third display region may be any region in the style template presentation interface, and optionally, may be a bottom region of the first display region.

In a practical application, after the at least one to-be-selected arrangement style is determined and a presentation order of each to-be-selected arrangement style is determined, the each to-be-selected arrangement style may be displayed in the first display region in the presentation order, while the at least one to-be-selected arrangement template associated with the to-be-selected arrangement style first presented is presented in the third display region. This arrangement has the advantages that the linkage interaction between the first display region and the third display region is achieved, meanwhile, the clear display of the to-be-selected arrangement template is achieved, and the use experience of the user is improved.

Exemplarily, referring again to FIG. 5, when the to-be-selected arrangement style first presented in the first display region is the arrangement style 1, at least one to-be-selected arrangement template associated with the arrangement style 1 may be presented in the third display region, that is, an arrangement template 1, an arrangement template 2, and an arrangement template 3.

In S260, the target arrangement style is determined in response to detecting that the to-be-selected arrangement style in the first display region is triggered.

In this embodiment, one or more to-be-selected arrangement styles presented in the first display region may be provided. If one to-be-selected arrangement style presented in the first display region is provided, the to-be-selected arrangement style may be used as the target arrangement style. If multiple to-be-selected arrangement styles presented in the first display region are provided, the target arrangement style may be determined by a trigger operation to any to-be-selected arrangement style.

In S270, the at least one to-be-selected arrangement template associated with the target arrangement style is updated and displayed in the third display region.

In this embodiment, after the target arrangement style is determined, at least one to-be-selected arrangement template corresponding to the target arrangement style may be called in the database, and the at least one to-be-selected arrangement template is displayed in the third display region.

It should be noted that the advantages of displaying the to-be-selected arrangement template corresponding to the target arrangement style in the third display region are that each to-be-selected arrangement template may be visually presented, and the display content in the second display region may be updated through the trigger operation to each presented to-be-selected arrangement template, thereby achieving the linkage interaction of the display content contained in each display region, and improving the use experience of the user.

In S280, the target audio is played based on a trigger operation to the at least one to-be-selected arrangement template.

In the practical application process, it may occur that the user is not satisfied with the determined at least one to-be-selected arrangement style and is to be replaced with another arrangement style, and at this time, a folding presentation control may be preset in any region of the first display region for presenting each to-be-selected arrangement style, so that multiple pre-stored to-be-matched arrangement styles may be presented in the display interface when a trigger operation to the folding presentation control is detected. It should be noted that at least two presentation manners may exist for the interface including multiple to-be-matched arrangement styles, and the two presentation manners may be respectively explained below.

One manner may be that: a presentation size of the style template presentation interface in the display interface is adjusted and a target interface including multiple to-be-matched arrangement styles is presented at a preset position of the display interface in response to detecting that the folding presentation control is triggered.

In this embodiment, the preset position may be any position in the display interface, and optionally, the preset position may be a left side, a right side, or a bottom of the adjusted style template presentation interface.

In a practical application, the folding presentation control may be preset in any region in the first display region. When a trigger operation to the folding presentation control is detected, the presentation size of the style template presentation interface in the display interface may be adjusted to a preset size. Moreover, a target interface including multiple to-be-matched arrangement styles may be displayed at a preset position in the display interface. Optionally, the preset size may be any size smaller than an initial presentation size of the style template presentation interface. This arrangement has the advantages that as much display content as possible in the limited interface space is achieved, the interface space is fully utilized, and the personalized requirements of the user are satisfied.

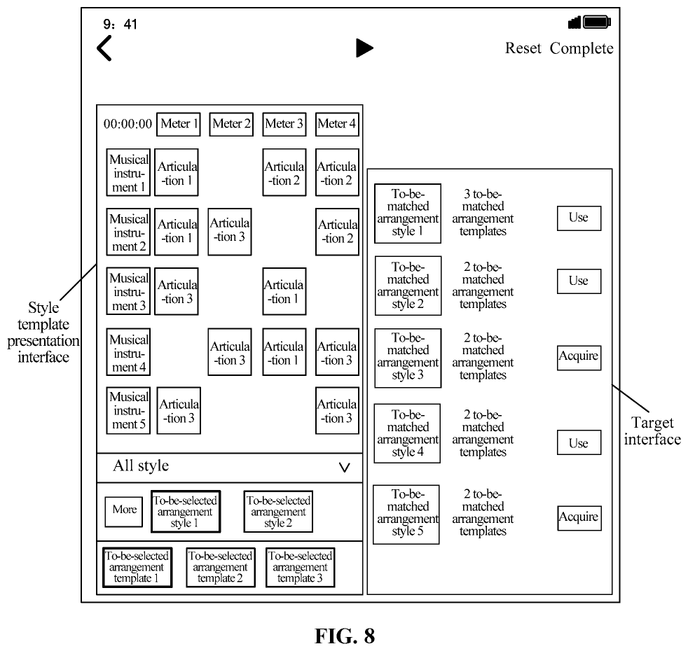

Exemplarily, as shown in FIG. 8, “ [symbol] ” in FIG. 8 is the folding presentation control. When the trigger operation to the control is detected, the presentation size of the style template presentation interface on the display interface may be reduced to one half of the initial presentation size, and a target interface including multiple to-be-matched arrangement styles may be presented on a left side region of the display interface.

Another manner may be that: in response to detecting that the folding presentation control is triggered, it jumps from the style template presentation interface to the target interface presenting and including the multiple to-be-matched arrangement styles.

In a practical application, when a trigger operation to the folding presentation control in the first display region is detected, it is possible to respond to the trigger operation, and then adjust from the style template presentation interface to the target interface so as to present the multiple to-be-matched arrangement styles in the target interface. This arrangement has the advantages that a clear presentation of the multiple to-be-matched arrangement styles can be achieved, the user to select an arrangement style satisfying the user requirements is facilitated, and the use experience of the user is improved.

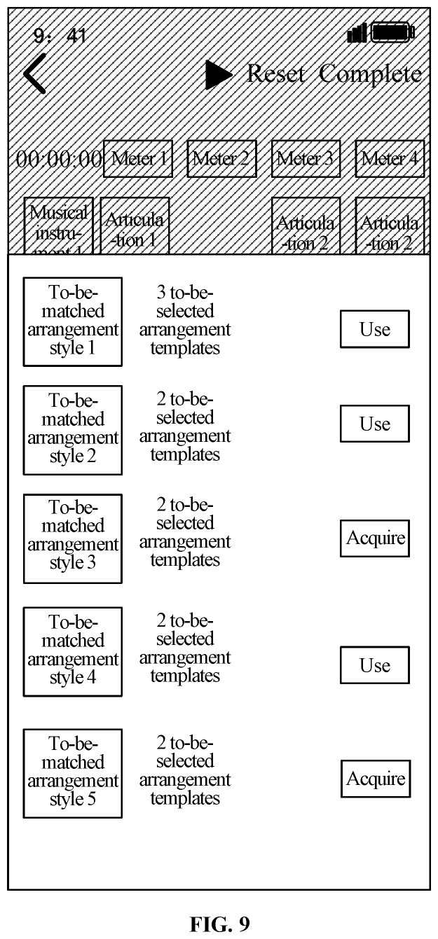

Exemplarily, referring again to FIG. 5, “ [symbol] ” in FIG. 5 is the folding presentation control. When the trigger operation to the control is detected, it jumps to the target interface shown in FIG. 9, the target interface shown in FIG. 9 includes 5 to-be-matched arrangement styles, namely, a to-be-matched arrangement style 1, a to-be-matched arrangement style 2, a to-be-matched arrangement style 3, a to-be-matched arrangement style 4, and a to-be-matched arrangement style 5, and moreover, a number of the to-be-selected arrangement templates associated with the to-be-matched arrangement style, as well as the use control and the acquisition control may be displayed in the target interface, and the control is used and acquired.

It should be noted that, after the target interface including the multiple to-be-matched arrangement styles is obtained, at least one to-be-matched arrangement style satisfying the user requirements may be added to the first display region, and moreover, at least one to-be-selected arrangement template associated with the to-be-matched arrangement style is presented in the third display region so that the user may determine a target audio to be finally played through trigger operation to a corresponding to-be-selected arrangement template.

Based on the above-described technical schemes, the method further includes that: in response to detecting that a use control corresponding to a to-be-matched arrangement style of the multiple to-be-matched arrangement styles is triggered, a triggered to-be-matched arrangement style is presented in the first display region of the style template presentation interface, and a to-be-selected arrangement template associated with the to-be-matched arrangement style of the multiple to-be-matched arrangement styles is presented in a third display region.

In the practical application process, the use control may be preset at any position of a presentation region of each to-be-matched arrangement style, and when a trigger operation to the use control corresponding to any to-be-matched arrangement style is detected, it is possible to respond to the trigger operation, at least one to-be-selected arrangement template associated with the to-be-matched arrangement style may be called, the to-be-matched arrangement style is presented in the first display region of the style template presentation interface, and moreover, at least one to-be-selected arrangement template associated with the to-be-matched arrangement style is presented in the third display region. This arrangement has the advantages that the effect of personalizing the display contents of the first display region and the third display region based on the user requirements can be achieved.

Exemplarily, referring again to FIG. 9, when a trigger operation to the use control corresponding to the to-be-matched arrangement style 1 is detected, the to-be-matched arrangement style 1 may be updated into the first display region, and three to-be-selected arrangement templates associated with the to-be-matched arrangement style 1 may be updated into the third display region.

Optionally, the triggered to-be-matched arrangement style is presented in the first display region of the style template presentation interface includes that: the triggered to-be-matched arrangement style is placed at a first position of the at least one to-be-selected arrangement style in the first display region, and the at least one to-be-selected arrangement style is adjusted according to a number of presentations of the first display region.

In this embodiment, the number of presentations may be a preset number of arrangement styles presented in the first display region.

In the practical application process, when the triggered to-be-matched arrangement style is presented in the first display region, the to-be-matched arrangement style may be presented in the first position of each to-be-selected arrangement style, and moreover, each to-be-selected arrangement style may be adjusted according to the number presented in the first display region. Specifically, if the number of presentations is less than the number of to-be-selected arrangement styles, then a to-be-selected arrangement style at the end may be removed from the first display region; if the number of presentations is equal to or greater than the number of to-be-selected arrangement styles, then each selected arrangement style may be sequentially presented in the first display region. This arrangement has the advantages that the effect of configuring the arrangement style in the first display region with a high degree of freedom is achieved, and moreover, the personalized requirements of the user are satisfied, and the use experience of the user is improved.

It should be noted that in order to reduce the memory usage of the application software in the terminal device, only a part of each to-be-matched arrangement style pre-stored in the application software may be loaded, and the non-loaded to-be-matched arrangement style may be loaded in real time in the practical application process, so that the to-be-matched arrangement style required by the user may be loaded into the corresponding display region.

Based on this, based on the above-described technical schemes, the method further includes: in response to detecting that an acquisition control corresponding to a to-be-matched arrangement style of the multiple to-be-matched arrangement styles is triggered, a to-be-selected arrangement template corresponding to a to-be-matched arrangement style of the multiple to-be-matched arrangement styles is acquired, the each to-be-matched arrangement style is displayed in the first display region, and the to-be-selected arrangement template corresponding to each to-be-matched arrangement style is displayed in a third display region.

In the practical application process, the acquisition control may be pre-developed and may be set in a display region corresponding to the to-be-matched arrangement style, and when a trigger operation to an acquisition control corresponding to any to-be-matched arrangement style by the user is detected, a to-be-selected arrangement template corresponding to the to-be-matched arrangement style may be loaded into the application software from multiple pre-stored to-be-selected arrangement templates, the to-be-matched arrangement style may be displayed in the first display region, and the to-be-selected arrangement template associated with the to-be-matched arrangement style is displayed in the third display region. This arrangement has the advantages that the memory occupancy of the application software in the terminal device can be reduced, and further, the processing efficiency of the application software for audio information is improved.

Exemplarily, referring again to FIG. 9, the control corresponding to the to-be-matched arrangement style 3 in FIG. 9 is the acquisition control, and two to-be-selected arrangement templates associated with the to-be-matched arrangement style 3 exist. If a trigger operation to the to-be-matched arrangement style 3 by the user is detected, then the to-be-matched arrangement style 3 may be displayed in the first display region of the style template presentation interface, and the two to-be-selected arrangement templates associated with the to-be-matched arrangement style 3 may be displayed in the third display region of the style template presentation interface.

According to technical schemes of the embodiments of the present disclosure, the chord corresponding to the input audio is determined in response to receiving the input audio, then the preview interface of the chord is displayed, the arrangement control is presented in the target region of the preview interface to determine the at least one to-be-selected arrangement style based on the trigger operation to the arrangement control, further, the at least one to-be-selected arrangement style is determined according to the chord and/or the melody attribute of the input audio, further, it jumps to the style template presentation interface to present the at least one to-be-selected arrangement style in the first display region of the style template presentation interface, and present the musical instrument information constituting the each of the at least one to-be-selected arrangement template and the articulation corresponding to each meter in the second display region of the style template presentation interface, then the at least one to-be-selected arrangement template associated with the target arrangement style is displayed based on the trigger operation to the at least one to-be-selected arrangement style, and finally the target audio is played based on the trigger operation to the at least one to-be-selected arrangement template, so that the target arrangement template is customized based on the user requirements to obtain the target audio based on the target arrangement template and the input audio, moreover, the visual presentation of the creation process of the target audio is achieved, whereby the user can browse more intuitively, the user requirements are satisfied, and the user experience is improved.

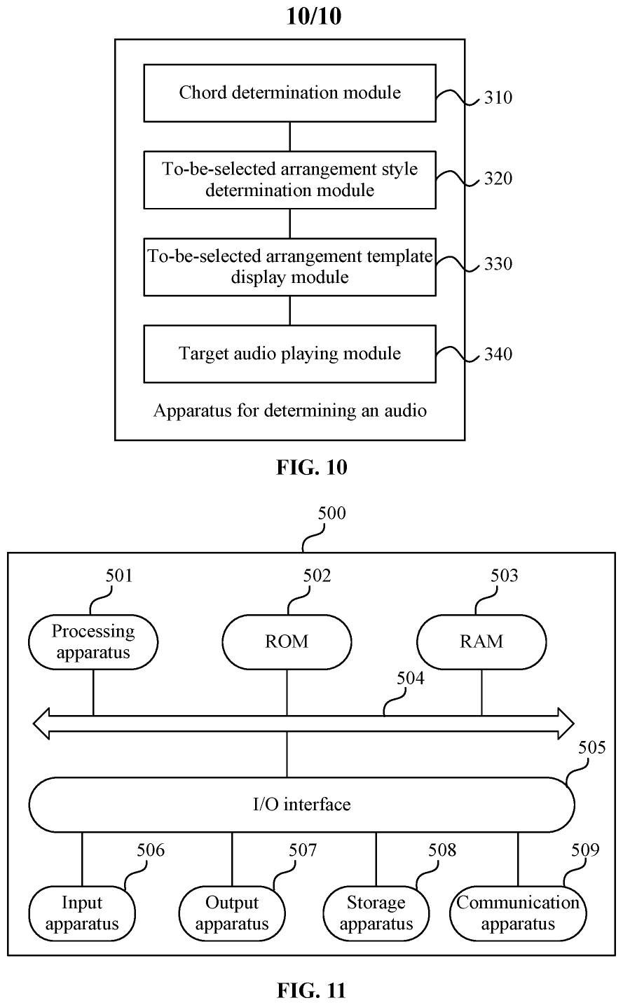

FIG. 10 is a schematic structural diagram of an apparatus for determining an audio according to an embodiment of the present disclosure. As shown in FIG. 10, the apparatus includes a chord determination module 310, a to-be-selected arrangement style determination module 320, a to-be-selected arrangement template display module 330, and a target audio playing module 340.

The chord determination module 310 is configured to determine a chord corresponding to an input audio in response to receiving the input audio. The to-be-selected arrangement style determination module 320 is configured to determine at least one to-be-selected arrangement style according to the chord and/or a melody attribute of the input audio. The to-be-selected arrangement template display module 330 is configured to display, based on a trigger operation to the at least one to-be-selected arrangement style, at least one to-be-selected arrangement template associated with a target arrangement style. The target audio playing module 340 is configured to play a target audio based on a trigger operation to the at least one to-be-selected arrangement template, where the target audio is an audio obtained after the input audio is merged to a target arrangement template, and the at least one to-be-selected arrangement template includes the target arrangement template.

Based on the above-described technical schemes, the apparatus further includes an audio information acquisition module and an input audio determination module.

The audio information acquisition module is configured to collect audio information of a target user in response to a special effect trigger operation, and use the audio information as the input audio; or the input audio determination module is configured to use the collected audio information as the input audio in response to detecting that an audio collection control is triggered.

Based on the above-described technical schemes, the apparatus further includes a preview interface display module and an arrangement control presentation module.

The preview interface display module is configured to display a preview interface of the chord after the chord is determined. The arrangement control presentation module is configured to present an arrangement control in a target region of the preview interface to determine the at least one to-be-selected arrangement style based on a trigger operation to the arrangement control.

Based on the above-described technical schemes, the melody attribute includes a tempo and a meter, and the to-be-selected arrangement style determination module 320 is specifically configured to determine the at least one to-be-selected arrangement style from multiple to-be-matched arrangement styles according to the tempo and/or the meter.

Based on the above-described technical schemes, the to-be-selected arrangement style determination module 320 is specifically configured to determine the at least one to-be-selected arrangement style from multiple to-be-matched arrangement styles according to the tempo, the meter and the chord.

Based on the above-described technical schemes, the apparatus further includes a to-be-selected arrangement style presentation module.

The to-be-selected arrangement style presentation module is configured to jump to a style template presentation interface to present the at least one to-be-selected arrangement style in a first display region of the style template presentation interface, and present musical instrument information constituting each of the at least one to-be-selected arrangement template and an articulation corresponding to each meter in a second display region of the style template presentation interface.

Based on the above-described technical schemes, a presentation order of the at least one to-be-selected arrangement style in the first display region is determined based on at least one of the following manners: a matching degree of each of the at least one to-be-selected arrangement style and the input audio; historical selection data of a target user for the at least one to-be-selected arrangement style; or a frequency at which the at least one to-be-selected arrangement style is selected by the target user.

Based on the above-described technical schemes, the apparatus further includes an articulation updating module.

The articulation updating module is configured to update the musical instrument information in the second display region and the articulation corresponding to each meter in the second display region in response to detecting that the at least one to-be-selected arrangement template is updated.

Based on the above-described technical schemes, the apparatus further includes a display content updating module.

The display content updating module is configured to update a display content of the second display region based on a trigger operation to the musical instrument information in the second display region and/or the articulation corresponding to each meter in the second display region.

Based on the above-described technical schemes, the trigger operation includes at least one of deleting, switching or adding.

Based on the above-described technical schemes, the apparatus further includes a to-be-selected arrangement template presentation module.

The to-be-selected arrangement template presentation module is configured to present, in a third display region of the style template presentation interface, at least one to-be-selected arrangement template associated with a to-be-selected arrangement style first presented in the first display region.

Based on the above-described technical schemes, the to-be-selected arrangement template display module 330 includes a target arrangement style determination unit and a to-be-selected arrangement template updating unit.

The target arrangement style determination unit is configured to determine the target arrangement style in response to detecting that the at least one to-be-selected arrangement style in the first display region is triggered. The to-be-selected arrangement template updating unit is configured to update and display the at least one to-be-selected arrangement template associated with the target arrangement style in the third display region.

Based on the above-described technical schemes, the first display region further includes a folding presentation control, and the apparatus further includes a presentation size adjustment module.

The presentation size adjustment module is configured to: in response to detecting that the folding presentation control is triggered, adjust a presentation size of a style template presentation interface in a display interface, and present, at a preset position of the display interface, a target interface including multiple to-be-matched arrangement styles.

Based on the above-described technical schemes, the first display region further includes a folding presentation control, and the apparatus further includes a presentation interface jump module.

The presentation interface jump module is configured to jump from a style template presentation interface to a target interface presenting and including multiple to-be-matched arrangement styles in response to detecting that the folding presentation control is triggered.

Based on the above-described technical schemes, the apparatus further includes a to-be-matched arrangement style presentation module.

The to-be-matched arrangement style presentation module is configured to: in response to detecting that a use control corresponding to a to-be-matched arrangement style of the multiple to-be-matched arrangement styles is triggered, present, in the first display region of the style template presentation interface, a triggered to-be-matched arrangement style, and present, in a third display region, a to-be-selected arrangement template associated with the to-be-matched arrangement style of the multiple to-be-matched arrangement styles.

Based on the above-described technical schemes, the to-be-matched arrangement style presentation module is specifically configured to: place the triggered to-be-matched arrangement style at a first position of the at least one to-be-selected arrangement style in the first display region, and adjust the at least one to-be-selected arrangement style according to a number of presentations of the first display region.

Based on the above-described technical schemes, the apparatus further includes a to-be-selected arrangement template acquisition module.

The to-be-selected arrangement template acquisition module is configured to: in response to detecting that an acquisition control corresponding to a to-be-matched arrangement style of the multiple to-be-matched arrangement styles is triggered, acquire a to-be-selected arrangement template corresponding to a to-be-matched arrangement style of the multiple to-be-matched arrangement styles, display the each to-be-matched arrangement style in the first display region, and display the to-be-selected arrangement template corresponding to each to-be-matched arrangement style in a third display region.

Based on the above-described technical schemes, the to-be-selected arrangement template is an arrangement template for fusing the input audio.

According to technical schemes of the embodiments of the present disclosure, the chord corresponding to the input audio is determined in response to receiving the input audio, then the at least one to-be-selected arrangement style is determined according to the chord and/or the melody attribute of the input audio, the at least one to-be-selected arrangement template associated with the target arrangement style is displayed based on the trigger operation to the at least one to-be-selected arrangement style, and the target audio is played based on the trigger operation to the at least one to-be-selected arrangement template, so that problems that in the related art, the personalized customization can not be performed on the input audio entered by the user and certain limitations exist are solved, the target arrangement template is determined based on the input audio entered by the user and the trigger operation to the arrangement template by the user, whereby the effect of fusing the input audio to the target audio of the target arrangement template is obtained, the personalized requirements of the user are satisfied, the use experience of the user on the application software is improved, and meanwhile, the interactive experience of the user and the display interface is improved.

The apparatus for determining the audio provided in the embodiments of the present disclosure may perform the method for determining the audio provided in any of the embodiments of the present disclosure, and has corresponding functional modules and beneficial effects for performing the method.

It is worth noting that the multiple units and modules included in the above-described apparatus are only divided according to the function logic and are not limited to the above division, as long as corresponding functions may be achieved; in addition, the name of each functional unit is also merely to facilitate distinguishing from each other and is not intended to limit the scope of protection of the embodiments of the present disclosure.

FIG. 11 is a schematic structural diagram of an electronic device according to an embodiment of the present disclosure. Referring to FIG. 11 below, FIG. 11 shows a schematic structural diagram of an electronic device (e.g., a terminal device or a server in FIG. 11) 500 suitable for implementing the embodiment of the present disclosure. The terminal device in the embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP) and an in-vehicle terminal (such as, an in-vehicle navigation terminal), and fixed terminals such as a digital TV and a desktop computer. The electronic device shown in FIG. 11 is merely one example and should not be construed as limiting the function and the scope of use of the embodiments of the present disclosure.

As shown in FIG. 11, the electronic device 500 may include a processing apparatus (such as a central processing unit and a graphics processor) 501, the processing apparatus 501 may perform various appropriate actions and processes according to a program stored in a read-only memory (ROM) 502 or a program loaded from a storage apparatus 508 into a random access memory (RAM) 503. Various programs and data required for the operation of the electronic device 500 are also stored in the RAM 503. The processing apparatus 501, the ROM 502 and the RAM 503 are connected to each other via a bus 504. An input/output (I/O) interface 505 is also connected to the bus 504.

Generally, following apparatuses may be connected to the I/O interface 505: an input apparatus 506 including such as a touch screen, a touchpad, a keyboard, a mouse, a camera, a microphone, an accelerometer and a gyroscope; an output apparatus 507 including such as a liquid crystal display (LCD), a speaker and a vibrator; a storage apparatus 508 including such as a magnetic tape and a hard disk; and a communication apparatus 509. The communication apparatus 509 may allow the electronic device 500 to communicate wirelessly or wired with other devices to exchange data. Although FIG. 11 shows the electronic device 500 having various apparatuses, it should be understood that not all of the shown apparatuses need be implemented or provided. More or fewer apparatuses may alternatively be implemented or provided.

In particular, according to the embodiments of the present disclosure, the process described above with reference to the flowcharts may be implemented as a computer software program. For example, an embodiment of the present disclosure provides a computer program product including a computer program carried on a non-transient computer-readable medium, and the computer program contains a program code for performing the method shown in the flowcharts. In such embodiments, the computer program may be downloaded and installed from the network through the communication apparatus 509, or installed from the storage apparatus 508, or installed from the ROM 502. When the computer program is executed by the processing apparatus 501, the above-described functions defined in the methods of the embodiments of the present disclosure are performed.

The names of messages or information exchanged between multiple apparatuses in the implementations of the present disclosure are for illustrative purposes only, and are not intended to limit the scope of such messages or information.

The electronic device provided in the embodiments of the present disclosure belongs to the same inventive concept as the method for determining the audio provided by the above-described embodiments, technical details not elaborately described in this embodiment may be referred to the above-described embodiments, and this embodiment has the same beneficial effects as the above-described embodiments.

An embodiment of the present disclosure provides a non-transitory computer storage medium storing a computer program thereon. The program, when executed by a processor, implements the method for determining the audio provided in the embodiments described above.

It should be noted that the above-described computer-readable medium of the present disclosure may be a computer-readable signal medium, or a computer-readable storage medium, or any combination of the computer-readable signal medium and the computer-readable storage medium. The computer-readable storage medium may be, for example, but not limited to, an electronic, magnetic, optical, electromagnetic, infrared, or semiconductor system, apparatus, or device, or any combination thereof. More specific examples of the computer-readable storage media may include, but are not limited to: electrical connections with one or more wires, a portable computer magnetic disk, a hard disk, a random access memory (RAM), a read only storage (ROM), an erasable programmable read only memory (EPROM or a flash), an optical fiber, a portable and compact disc read-only memory (CD-ROM), an optical storage device, a magnetic storage device, or any suitable combination thereof. In the present disclosure, the computer-readable storage medium may be any tangible medium that contains or stores a program, which may be used by or in combination with an instruction execution system, apparatus, or device. In the present disclosure, the computer-readable signal medium may include a data signal that is contained in a baseband or propagated as a part of a carrier wave. and the data signal carries a computer-readable program code. Such a propagated data signal may take many forms, including but not limited to an electromagnetic signal, an optical signal, or any suitable combination thereof. The computer-readable signal medium may also be any computer-readable medium other than the computer-readable storage medium, and the computer-readable signal medium may send, propagate, or transmit a program for being used by or in combination with the instruction execution system, apparatus, or device. The program code contained in the computer-readable medium may be transmitted by using any appropriate medium, including but not limited to an electric wire, an optical cable, a radio frequency (RF), and the like, or any suitable combination thereof.

In some embodiments, the client and server may communicate by using any currently known or future developed network protocol, such as hypertext transfer protocol (HTTP), and may be interconnected with any form or medium of digital data communication (such as, a communication network). Examples of communication networks include a local area network (“LAN”), a wide area network (“WAN”), an internetwork (such as, the Internet), and a peer-to-peer network (such as, an ad hoc peer-to-peer network), and any currently known or future developed network.

The above-described computer-readable medium may be included in the above-described electronic device, and the above-described computer-readable medium may also exist separately and not be fitted into the electronic device.

The above-described computer-readable medium carries one or more programs, the one or more programs, when executed by the electronic device, cause the electronic device to: determine a chord corresponding to an input audio in response to receiving the input audio; determine at least one to-be-selected arrangement style according to the chord and/or a melody attribute of the input audio; display, based on a trigger operation to the at least one to-be-selected arrangement style, at least one to-be-selected arrangement template associated with a target arrangement style; and play a target audio based on a trigger operation to the at least one to-be-selected arrangement template; where the target audio is an audio obtained after the input audio is merged to a target arrangement template, and the at least one to-be-selected arrangement template includes the target arrangement template.

Or, the above-described computer-readable medium carries one or more programs, the one or more programs, when executed by the electronic device, cause the electronic device to: determine a chord corresponding to an input audio in response to receiving the input audio; determine at least one to-be-selected arrangement style according to the chord and/or a melody attribute of the input audio; display, based on a trigger operation to the at least one to-be-selected arrangement style, at least one to-be-selected arrangement template associated with a target arrangement style; and play a target audio based on a trigger operation to the at least one to-be-selected arrangement template; where the target audio is an audio obtained after the input audio is merged to a target arrangement template, and the at least one to-be-selected arrangement template includes the target arrangement template.

A computer program code for performing the operations of the present application may be written in one or more programming languages or combinations thereof, the described programming languages include an object-oriented programming language—such as Java, Smalltalk, C++, and further include a conventional procedural programming language—such as a “C” language or similar programming language. The program code may be executed in following manners: executed entirely on a user's computer, executed partly on the user's computer, executed as an independent software package, executed partly on the user's computer and partly on a remote computer, or executed entirely on the remote computer or a server. In a case where the remote computer is involved, the remote computer may be connected to the user's computer through any kind of network, including a local area network (LAN) or a wide area network (WAN), or may be connected to an external computer (for example, connected to the external computer through an internet provided by an internet service provider).

The flowchart and block diagram in the drawings illustrate the architecture, functionality, and operation of possible implementations of the system, the method and the computer program product according to various embodiments of the present disclosure. In this regard, each block in the flowchart or block diagram may represent a module, a program segment, or a part of codes, which includes one or more executable instructions for implementing a specified logical function. It should also be noted that, in some alternative implementations, the functions noted in the blocks may occur out of the order noted in the drawings. For example, two blocks shown in succession may, in fact, be executed substantially concurrently, or the two blocks may sometimes be executed in a reverse order, which depends upon the involved functionality. It should also be noted that each block of the block diagram and/or the flowchart, and combinations of blocks of the block diagram and/or the flowchart, may be implemented by a dedicated hardware-based system that performs a specified function or operation, or by a combination of a dedicated hardware and a computer instruction.

The unit described in the embodiments of the present disclosure may be implemented by a software or a hardware. The name of the unit does not constitute a limitation on the unit itself in some cases. For example, a first acquisition unit may also be described as “a unit for acquiring the at least two Internet protocol addresses”.

The functions described above herein may be performed, at least in part, by one or more hardware logic components. For example, without limitation, exemplary types of hardware logic components that may be used include a field-programmable gate array (FPGA), an application-specific integrated circuit (ASIC), an application-specific standard product (ASSP), a system-on-a-chip system (SOC), a complex programmable logic device (CPLD), and the like.

In the context of the present disclosure, a machine-readable medium may be a tangible medium that may contain or store a program available for an instruction execution system, apparatus or device or a program used in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any appropriate combination of the foregoing. More specific examples of the machine-readable storage medium may include an electrical connection based on one or more wires, a portable computer diskette, a hard disk, a random access memory (RAM), a read-only memory (ROM), an erasable programmable read-only memory (EPROM) or a flash memory, an optical fiber, a portable compact disc read-only memory (CD-ROM), an optical storage device, a magnetic storage device, or any appropriate combination of the foregoing.

According to one or more embodiments of the present disclosure, [example one] provides a method for determining an audio, the method includes that: a chord corresponding to an input audio is determined in response to receiving the input audio; at least one to-be-selected arrangement style is determined according to the chord and/or a melody attribute of the input audio; at least one to-be-selected arrangement template associated with a target arrangement style is displayed based on a trigger operation to the at least one to-be-selected arrangement style; and a target audio is played based on a trigger operation to the at least one to-be-selected arrangement template. The target audio is an audio obtained after the input audio is merged to a target arrangement template, and the at least one to-be-selected arrangement template includes the target arrangement template.

According to one or more embodiments of the present disclosure, [example two] provides a method for determining an audio, the method further includes: optionally, audio information of a target user is collected in response to a special effect trigger operation, and the audio information is used as the input audio: or the collected audio information is used as the input audio in response to detecting that an audio collection control is triggered.

According to one or more embodiments of the present disclosure, [example three] provides a method for determining an audio, after the chord is determined, the method further includes: optionally, a preview interface of the chord is displayed; and an arrangement control is presented in a target region of the preview interface to determine the at least one to-be-selected arrangement style based on a trigger operation to the arrangement control.

According to one or more embodiments of the present disclosure, [example four] provides a method for determining an audio, the melody attribute includes a tempo and a meter, and the method further includes: optionally, the at least one to-be-selected arrangement style is determined from multiple to-be-matched arrangement styles according to at least one of the tempo or the meter.

According to one or more embodiments of the present disclosure, [example five] provides a method for determining an audio, the method further includes: optionally, the at least one to-be-selected arrangement style is determined from multiple to-be-matched arrangement styles according to the tempo, the meter and the chord.

According to one or more embodiments of the present disclosure, [example six] provides a method for determining an audio, after the at least one to-be-selected arrangement style is determined, the method further includes: optionally, it jumps to a style template presentation interface to present the at least one to-be-selected arrangement style in a first display region of the style template presentation interface, and present musical instrument information constituting each of the at least one to-be-selected arrangement template and an articulation corresponding to each meter in a second display region of the style template presentation interface.

According to one or more embodiments of the present disclosure, [example seven] provides a method for determining an audio, the method further includes: optionally, a presentation order of the at least one to-be-selected arrangement style in the first display region is determined based on at least one of the following manners: a matching degree of each of the at least one to-be-selected arrangement style and the input audio: historical selection data of a target user for the at least one to-be-selected arrangement style; or a frequency at which the at least one to-be-selected arrangement style is selected by the target user.

According to one or more embodiments of the present disclosure, [example eight] provides a method for determining an audio, the method further includes: optionally, the musical instrument information in the second display region and the articulation corresponding to each meter in the second display region are updated in response to detecting that the at least one to-be-selected arrangement template is updated.

According to one or more embodiments of the present disclosure, [example nine] provides a method for determining an audio, the method further includes: optionally, a display content of the second display region is updated based on a trigger operation to the musical instrument information in the second display region and/or the articulation corresponding to each meter in the second display region.

According to one or more embodiments of the present disclosure, [example ten] provides a method for determining an audio, the method further includes: optionally, the trigger operation includes at least one of deleting, switching or adding.

According to one or more embodiments of the present disclosure, [example eleven] provides a method for determining an audio, the method further includes: optionally, at least one to-be-selected arrangement template associated with a to-be-selected arrangement style first presented in the first display region is presented in a third display region of the style template presentation interface.

According to one or more embodiments of the present disclosure, [example twelve] provides a method for determining an audio, the method further includes: optionally, the target arrangement style is determined in response to detecting that the at least one to-be-selected arrangement style in the first display region is triggered; and the at least one to-be-selected arrangement template associated with the target arrangement style is updated and displayed in the third display region.

According to one or more embodiments of the present disclosure, [example thirteen] provides a method for determining an audio, a first display region further includes a folding presentation control, and the method further includes: optionally, in response to detecting that the folding presentation control is triggered, a presentation size of a style template presentation interface in a display interface is adjusted, and a target interface including multiple to-be-matched arrangement styles is presented at a preset position of the display interface.

According to one or more embodiments of the present disclosure, [example fourteen] provides a method for determining an audio, a first display region further includes a folding presentation control, and the method further includes: optionally, in response to detecting that the folding presentation control is triggered, it jumps from a style template presentation interface to a target interface presenting and including multiple to-be-matched arrangement styles.

According to one or more embodiments of the present disclosure, [example fifteen] provides a method for determining an audio, the method further includes: optionally, in response to detecting that a use control corresponding to a to-be-matched arrangement style of the multiple to-be-matched arrangement styles is triggered, a triggered to-be-matched arrangement style is presented in the first display region of the style template presentation interface, and a to-be-selected arrangement template associated with the to-be-matched arrangement style of the multiple to-be-matched arrangement styles is presented in a third display region.

According to one or more embodiments of the present disclosure, [example sixteen] provides a method for determining an audio, the method further includes: optionally, the triggered to-be-matched arrangement style is placed at a first position of the at least one to-be-selected arrangement style in the first display region, and the at least one to-be-selected arrangement style is adjusted according to a number of presentations of the first display region.

According to one or more embodiments of the present disclosure, [example seventeen] provides a method for determining an audio, the method further includes: optionally, in response to detecting that an acquisition control corresponding to a to-be-matched arrangement style of the multiple to-be-matched arrangement styles is triggered, a to-be-selected arrangement template corresponding to a to-be-matched arrangement style of the multiple to-be-matched arrangement styles is acquired, the each to-be-matched arrangement style is displayed in the first display region, and the to-be-selected arrangement template corresponding to each to-be-matched arrangement style is displayed in a third display region.

According to one or more embodiments of the present disclosure, [example eighteen] provides a method for determining an audio, the method further includes: optionally, the to-be-selected arrangement template is an arrangement template for fusing the input audio.

According to one or more embodiments of the present disclosure, [example nineteen] provides an apparatus for determining an audio, the apparatus includes a chord determination module, a to-be-selected arrangement style determination module, a to-be-selected arrangement template display module, and a target audio playing module. The chord determination module is configured to determine a chord corresponding to an input audio in response to receiving the input audio. The to-be-selected arrangement style determination module is configured to determine at least one to-be-selected arrangement style according to the chord and/or a melody attribute of the input audio. The to-be-selected arrangement template display module is configured to display, based on a trigger operation to the at least one to-be-selected arrangement style, at least one to-be-selected arrangement template associated with a target arrangement style. The target audio playing module is configured to play a target audio based on a trigger operation to the at least one to-be-selected arrangement template, where the target audio is an audio obtained after the input audio is merged to a target arrangement template, and the at least one to-be-selected arrangement template includes the target arrangement template.

The foregoing description is merely the preferred embodiment of the present disclosure and illustrative of the principles of the technologies employed. It should be understood by those skilled in the art that the scope of the disclosure involved in the present disclosure is not limited to the technical scheme formed by the specific combination of the above technical features, but also covers other technical schemes formed by any combination of the above-described technical features or their equivalent features without departing from the concept of the above-described disclosure, such as a technical scheme formed by the above-described features being replaced with the technical features disclosed in the present disclosure (but not limited to) having similar functions.

Further, while operations are depicted in a particular order, this should not be understood as requiring that such operations be performed in the particular order shown or in sequential order. In certain circumstances, multitasking and parallel processing may be advantageous. Likewise, while several specific implementation details are included in the above discussion, these should not be construed as limitations on the scope of the present disclosure. Certain features that are described in the context of separate embodiments may also be implemented in combination in a single embodiment. Conversely, various features that are described in the context of the single embodiment may also be implemented in multiple embodiments separately or in any suitable sub-combination.

Although the subject matter has been described in language specific to structural features and/or methodological acts, it should be understood that the subject matter defined in the appended claims is not necessarily limited to the specific features or acts described above. Rather, the specific features and acts described above are merely example forms of implementing the claims.

What is claimed is:

1. A method for determining an audio, comprising:
in response to receiving an input audio, determining a chord corresponding to the input audio;
determining at least one to-be-selected arrangement style according to at least one of the chord or a melody attribute of the input audio;
displaying, based on a trigger operation to the at least one to-be-selected arrangement style, at least one to-be-selected arrangement template associated with a target arrangement style; and
playing a target audio based on a trigger operation to the at least one to-be-selected arrangement template;
wherein the target audio is an audio obtained after the input audio is merged to a target arrangement template, and the at least one to-be-selected arrangement template comprises the target arrangement template.

2. The method of claim 1, further comprising:
collecting audio information of a target user in response to a special effect trigger operation, and using the audio information as the input audio; or
in response to detecting that an audio collection control is triggered, using collected audio information as the input audio.

3. The method of claim 1, wherein after determining the chord, the method further comprises:
displaying a preview interface of the chord; and
presenting an arrangement control in a target region of the preview interface to determine the at least one to-be-selected arrangement style based on a trigger operation to the arrangement control.

4. The method of claim 1, wherein the melody attribute comprises a tempo and a meter, and determining the at least one to-be-selected arrangement style according to the melody attribute of the input audio comprises:
determining the at least one to-be-selected arrangement style from a plurality of to-be-matched arrangement styles according to at least one of the tempo or the meter.

5. The method of claim 1, wherein determining the at least one to-be-selected arrangement style according to the melody attribute of the input audio and the chord comprises:
determining the at least one to-be-selected arrangement style from a plurality of to-be-matched arrangement styles according to the tempo, the meter and the chord.

6. The method of claim 1, wherein after determining the at least one to-be-selected arrangement style, the method further comprises:
jumping to a style template presentation interface to present the at least one to-be-selected arrangement style in a first display region of the style template presentation interface, and to present musical instrument information constituting each of the at least one to-be-selected arrangement template and an articulation corresponding to each meter in a second display region of the style template presentation interface.

7. The method of claim 6, wherein a presentation order of the at least one to-be-selected arrangement style in the first display region is determined based on at least one of the following manners:
a matching degree of each of the at least one to-be-selected arrangement style and the input audio;
historical selection data of a target user for the at least one to-be-selected arrangement style; or
a frequency at which the at least one to-be-selected arrangement style is selected by the target user.

8. The method of claim 6, further comprising:
updating the musical instrument information in the second display region and the articulation corresponding to each meter in the second display region are updated in response to detecting that the at least one to-be-selected arrangement template is updated.

9. The method of claim 6, further comprising:
updating a display content of the second display region based on a trigger operation to at least one of the musical instrument information in the second display region or the articulation corresponding to each meter in the second display region.

10. The method of claim 9, wherein the trigger operation to the at least one of the musical instrument information in the second display region or the articulation corresponding to the each meter in the second display region comprises at least one of deleting, switching or adding.

11. The method of claim 6, further comprising:
presenting, in a third display region of the style template presentation interface, at least one to-be-selected arrangement template associated with a to-be-selected arrangement style first presented in the first display region.

12. The method of claim 6, wherein displaying, based on the trigger operation to the at least one to-be-selected arrangement style, the at least one to-be-selected arrangement template associated with the target arrangement style comprises:
in response to detecting that the at least one to-be-selected arrangement style in the first display region is triggered, determining the target arrangement style; and
updating and displaying the at least one to-be-selected arrangement template associated with the target arrangement style in the third display region.

13. The method of claim 1, wherein a first display region further comprises a folding presentation control, and the method further comprises:
in response to detecting that the folding presentation control is triggered, adjusting a presentation size of a style template presentation interface in a display interface, and presenting, at a preset position of the display interface, a target interface comprising a plurality of to-be-matched arrangement styles.

14. The method of claim 1, wherein a first display region further comprises a folding presentation control, and the method further comprises:
in response to detecting that the folding presentation control is triggered, jumping from a style template presentation interface to a target interface comprising a plurality of to-be-matched arrangement styles.

15. The method of claim 13, further comprising:
in response to detecting that a use control corresponding to a to-be-matched arrangement style of the plurality of to-be-matched arrangement styles is triggered, presenting, in the first display region of the style template presentation interface, a triggered to-be-matched arrangement style, and presenting, in a third display region, a to-be-selected arrangement template associated with the to-be-matched arrangement style of the plurality of to-be-matched arrangement styles; or
in response to detecting that an acquisition control corresponding to a to-be-matched arrangement style of the plurality of to-be-matched arrangement styles is triggered, acquiring a to-be-selected arrangement template corresponding to the to-be-matched arrangement style of the plurality of to-be-matched arrangement styles, displaying the to-be-matched arrangement style in the first display region, and displaying the to-be-selected arrangement template corresponding to the to-be-matched arrangement style in a third display region.

16. The method of claim 15, wherein presenting, in the first display region of the style template presentation interface, the triggered to-be-matched arrangement style, comprises:
placing the triggered to-be-matched arrangement style at a first position of the at least one to-be-selected arrangement style in the first display region, and adjusting the at least one to-be-selected arrangement style according to a number of presentations of the first display region.

17. An electronic device, comprising:
at least one processor;
a storage apparatus, which is configured to store at least one program;
wherein the at least one program, when executed by the at least one processor, causes the at least one processor to implement the method for determining the audio of claim 1.

18. A non-transitory storage medium comprising a computer-executable instruction, wherein the computer-executable instruction is configured to perform, when executed by a computer processor, the method for determining the audio of claim 1.
